(19) United States
(12) Patent Application Publication
(10) Pub. No.: US 2006/0077626 A1
(43) Pub. Date: Apr. 13, 2006

(54) Flat image display device

(76) Inventors: Nobuo Masuoka, Chigasaki (JP); Yoshie Kodera, Chigasaki (JP); Tetsu Ohishi, Hiratsuka (JP); Masakazu Sagawa, Inagi (JP); Akinori Maeda, Yokohama (JP)

Correspondence Address: MCDERMOTT WILL & EMERY LLP, 600 13TH STREET, N.W., WASHINGTON, DC, 20005-3096, US

(21) Appl. No.: 11/104,665

(22) Filed: Apr. 13, 2005

(30) Foreign Application Priority Data
Apr. 13, 2004 (JP) 2004-117868

(51) Int. Cl. G06F 1/16

(52) U.S. Cl. 361/681

(57) ABSTRACT

The present invention provides a flat image display device having a support frame that is compatible with a large flat image display device and has a high bonding strength. The invention relates to a flat image display device including: a display substrate; a back substrate disposed opposite the display substrate with a specified clearance therebetween; and a frame glass disposed around the back substrate and the display substrate, for supporting the substrates with the specified clearance therebetween. The invention is characterized in that the frame glass includes frame glasses whose ends each have at least two steps and the stepped ends are in engagement with each other and bonded together.

### BACKGROUND OF THE INVENTION

1. Field of the Invention

The present invention relates to a display unit, and in particular, it relates to a self-luminous flat image display device surrounded by a pair of substrates disposed oppositely with a clearance therebetween and a support frame that holds the periphery of the substrate pair with the clearance therebetween, inside of which is vacuum-sealed.

2. Description of the Related Art

Examples of a low-profile self-luminous flat image display device that is surrounded by a pair of substrates (a display substrate and a back substrate) disposed oppositely and a support frame that holds the periphery of the substrate pair with a clearance therebetween, inside of which is vacuum-sealed, adopt a thin flat panel such as a plasma display panel (hereinafter, referred to as a PDP) and a field emission display panel (hereinafter, referred to as an FED). The height of the support frame that holds the periphery of the substrate pair with a specified clearance is approximately 100 μm for PDPs and about 2 mm to 5 mm for FEDs depending on the shape of the electron emission element.

Known FEDs include a surface-conduction emission element, a field emission element, and a metal-insulator-metal emission element (hereinafter, referred to as an MIM). For example, an MIM-FED is disclosed in JP-A-2000-294170 (Patent Document 1). The MIM-FED includes a back substrate on which cold-cathode electron emission elements formed on an insulative substrate are disposed in matrix form to form an electron source, and a display substrate having phosphors in three primary colors of RGB which are formed on a light-transmissive substrate such as glass and emit light by irradiation of electrons from the electron source and a metal back formed on the phosphors. These substrates are opposed with a specified space therebetween, the peripheries of which are sealed by a frame glass serving as a support frame (also referred to as a side wall) using frit glass and so on. The interior thus formed is vacuum-sealed to approximately 10⁻⁵ to 10⁻⁷ torr. Electrons emitted from the electron emission elements (electron source) on the back substrate excite the phosphors on the display substrate, so that image light is emitted from the display substrate toward a viewer.

The rectangular frame glass serving as a support frame has been molded of, e.g., blue plate glass, into one piece. For example, an art disclosed in JP-A-2000-323073 (Patent Document 2) uses four long plate glasses (hereinafter, referred to as frame glasses) in the form of a rectangular frame. An art disclosed in JP-A-2000-311630 (Patent Document 3) adopts a rectangular frame that is formed by bending a rod made of a substantially rectangular-in-section blue plate glass into a rectangle shape by hot drawing or by cutting four long plate glasses from a glass substrate and welding it with a burner.

The height of the support frame for the FED is approximately 2 mm to 5 mm in the above-described art. However, it can be decreased to approximately 1 mm when the voltage applied to the anode electrode is low. This, however, increases the density of current that flows in the phosphors to accelerate the degradation of the phosphors. Accordingly, a high voltage, e.g., 10 KV is normally applied and the height of the support shaft is set at 2 mm or more.

The flat image display device disclosed in Patent Document 1 has a relatively small display screen, e.g., a display substrate of 55 mm×75 mm in size. A frame glass used in such a small flat image display device is molded in one piece. However, the one-piece molding costs much for a large display screen (e.g., 30 inches or more), posing the problem of cost. Also, a warp in the molded glass makes it difficult to provide high flatness in the surface in contact with the substrate, generating a clearance between the frame glass and the substrate. This also produces the problem of the need for a large amount of sealant to closely bond the frame glass and the substrate.

Accordingly, a method for manufacturing a frame glass 51 is proposed in Patent Document 2, as shown in of FIG. 9, in which a frame glass is divided into frame glasses 51ₐ and 51_{b}, which are bonded together with an adhesive and so on. This structure allows application to a large flat image display device. The frame glasses 51ₐ and 51_{b} can easily be made by cutting a glass plate, generating no warp due to molding because they are produced by cutting. Also, this produces little clearance between the frame glass 51 and the display substrate 2 and between the frame glass 51 and the back substrate 3 because it provides the accuracy of cutting relatively easily.

The space between the display substrate 2 and the back substrate 3 is approximately 2 to 5 mm, i.e., the height H₅ of the frame glass 51 is approximately 2 mm to 5 mm, as described above, and the width W₅ of the frame glasses 51ₐ and 51_{b} is also approximately 3 to 5 mm. Accordingly, a sufficient joint area for the frame glasses 51ₐ and 51_{b} cannot be provided. Also, this is resistant to a force in a drawing direction (x-direction) but is not resistant to a force in a shearing direction (in the direction perpendicular to the x-axis) because the joint surface is only in the y-z plane. Accordingly, in the process of assembling a flat display device, when the frame glass 51 bonded in the form of a rectangular frame is moved by holding two opposing frame glasses of the four frame glasses, the stress due to the weight of frame glasses that are not held concentrates in the direction in which the joint portion is sheared. This produces the problem that the joint portion easily comes off.

In the art disclosed in Patent Document 3, the flatness differs in a portion that is bent or welded with a burner and so on. This produces a clearance between the frame glass and the substrate, thus needing a large amount of sealant for bonding the frame glass and the substrate to seal the joint portion. The art therefore poses a problem in sealing. SUMMARY OF THE INVENTION

The invention has been made in light of such circumstances, and has as an object the provision of a flat image display device having a support frame that is compatible with a large flat image display device and has a high bonding strength.

The invention is characterized in the structure according to the appended claims. Specifically, the frame glass serving as a support frame used in the flat image display device of the invention is composed of four frame glasses, which are bonded together to form the frame glass. The bonding strength can be increased by a structure in which the ends of the frame glasses are shaped like a step, which are brought into engagement with each other and bonded together.

The invention is applied to a flat image display device including: a display substrate; a back substrate disposed opposite the display substrate with a specified clearance therebetween; and a frame glass disposed around the back substrate and the display substrate, for supporting the substrates with the specified clearance therebetween. According to a first aspect of the invention, the frame glass includes frame glasses whose ends each have at least two steps and the stepped ends are in engagement with each other and bonded together.

Preferably, the frame glass is produced by bonding the same number of plate glasses as that of the steps at the ends.

The plate glasses may be bonded with the ends of the adjacent plate glasses shifted by W/n, where W is the width of the frame glass and n is the number of bonded plate glasses.

According to a second aspect of the invention, the frame glass includes a frame glass whose end has a projection and a corner glass whose end has a recessed portion, the projecting end of the frame glass is fitted in the recessed end of the corner glass and bonded together.

The frame glass may be produced by bonding three plate glasses. Alternatively, the corner glass may be produced by molding.

According to a third aspect of the invention, the frame glass includes a frame glass whose end has a recessed portion and a corner glass whose end has a projection, the projecting end of the corner glass is fitted in the recessed end of the frame glass and bonded together.

The frame glass may be produced by bonding three plate glasses. Alternatively, the corner glass may be produced by molding.

According to embodiments of the invention, there is provided a flat image display device having a support frame that is compatible with a large flat image display device and has a high bonding strength.

### BRIEF DESCRIPTION OF THE DRAWINGS

FIG. 1 is a schematic diagram of a flat image display device according to a first embodiment of the present invention;

FIG. 2A is an enlarged exploded view of part of a frame glass according to the first embodiment;

FIG. 2B is an enlarged assembled view of part of the frame glass according to the first embodiment;

FIG. 3 is a schematic diagram of a flat image display device according to a second embodiment of the invention;

FIG. 4A is an enlarged exploded view of part of a frame glass according to the second embodiment;

FIG. 4B is an enlarged assembly view of part of the frame glass according to the second embodiment;

FIG. 5 is a schematic diagram of a flat image display device according to a third embodiment of the invention;

FIG. 6A is an enlarged exploded view of part of a frame glass according to the third embodiment;

FIG. 6B is an enlarged assembly view of part of the frame glass according to the third embodiment;

FIG. 7 is a schematic diagram of a flat image display device according to a fourth embodiment of the invention;

FIG. 8A is an enlarged exploded view of part of a frame glass according to the fourth embodiment;

FIG. 8B is an enlarged assembly view of part of the frame glass according to the fourth embodiment;

FIG. 9 is a schematic diagram of a flat image display device according to a related art;

FIG. 10 is a schematic diagram of an example of a back substrate;

FIG. 11 is a schematic diagram of an example of a display substrate;

FIG. 12 is a schematic diagram of a flat image display device according to a fifth embodiment of the invention;

FIG. 13A is an enlarged exploded view of part of a frame glass according to the fifth embodiment;

FIG. 13B is an enlarged assembly view of part of the frame glass according to the fifth embodiment;

FIG. 14 is a schematic diagram of a flat image display device according to a sixth embodiment of the invention;

FIG. 15A is an enlarged exploded view of part of a frame glass according to the sixth embodiment;

FIG. 15B is an enlarged assembly view of part of the frame glass according to the sixth embodiment;

FIG. 16 is a schematic diagram of a flat image display device according to a seventh embodiment of the invention;

FIG. 17A is an enlarged exploded view of part of a frame glass according to the seventh embodiment; and

FIG. 17B is an enlarged assembly view of part of the frame glass according to the seventh embodiment.

### DESCRIPTION OF THE PREFERRED EMBODIMENTS

Preferred embodiments of the present invention will be described.

The invention is described in detail below based on embodiments, with reference to the attached drawings. Like reference numerals designate like or corresponding parts throughout.

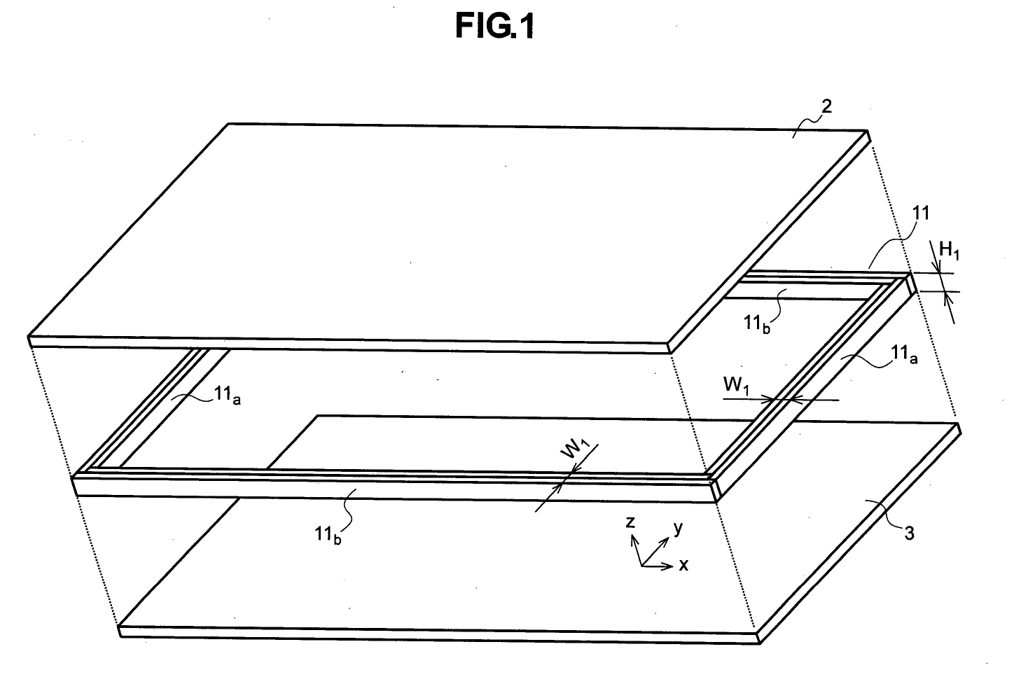

FIG. 1 is a schematic diagram of a flat image display device according to a first embodiment of the invention. In FIG. 1, the flat image display device includes a display substrate 2 having a phosphor (not shown) and a metal back (not shown) on the inside, a back substrate 3 having an electron source (not shown), and a frame glass 11 that supports the periphery between the opposing display substrate 2 and back substrate 3.

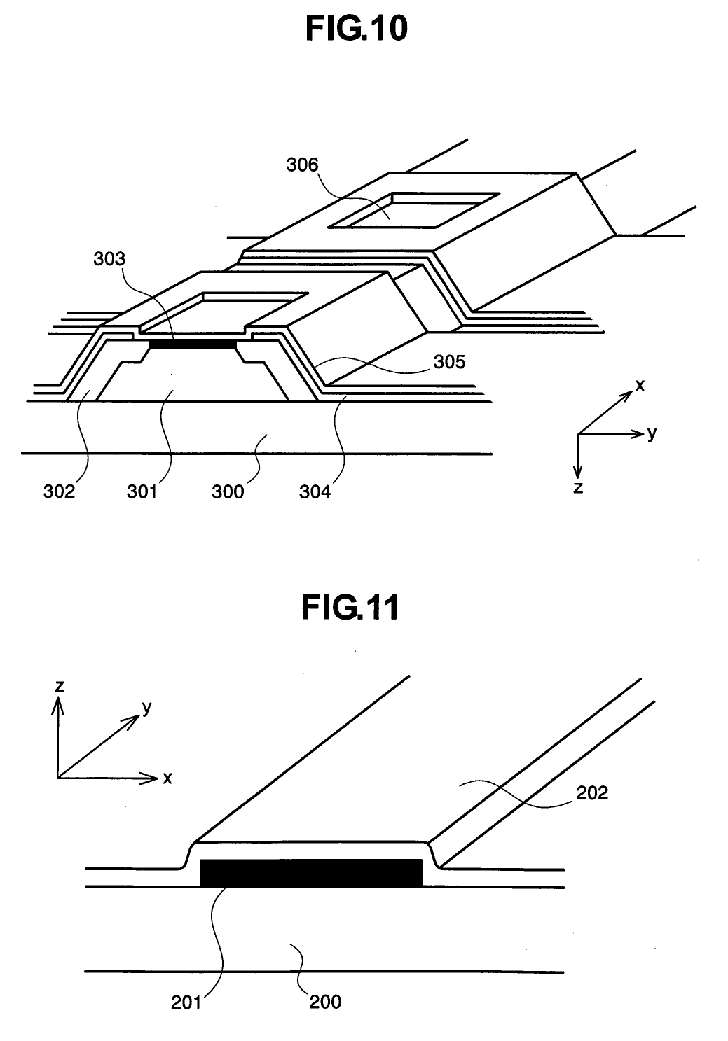

FIG. 10 is a schematic diagram of an example of the back substrate 3. In FIG. 10, the back substrate 3 includes a stripe lower electrode 301 extending in the X-direction on an insulative glass substrate 300 such as soda-lime glass, an electric-field reduction layer 302 and a tunnel dielectric layer 303 formed on the lower electrode 301, a stripe bus electrode 304 extending in the Y-direction on the electric-field reduction layer 302 and the tunnel dielectric layer 303, and an upper electrode 305 formed on the bus electrode 304. The lower electrode 301 and the bus electrode 304 intersect substantially at right angles. An electron emitter 306 is provided at part of an area where the lower electrode 301 and the bus electrode 304 overlap. The electron emitter 306 has no bus electrode 304, at which the upper electrode 305 faces the lower electrode 301 via the tunnel dielectric layer 303. Multiple electron emitters 306 are disposed to construct a small electron-source array structure.

FIG. 11 is a schematic diagram of an example of the display substrate 2. In FIG. 11, the display substrate 2 is constructed such that a phosphor stripe 201 composed of red, blue, and green stripe phosphors extending in the Y-direction, and a metal back (Al) layer 202 formed on the phosphor stripe 201 are formed on a light-transmissive glass substrate 200 such as soda-lime glass.

An example of a method for manufacturing the flat image display device according to an embodiment of the invention will be described below. The display substrate 2 of 3 mm in thickness, the frame glass 11 of 3 mm in height, and the back substrate 3 of 3 mm in thickness are assembled by applying glass paste as sealant to the contact portions, and are then sealed by heat treatment. It is evacuated through an exhaust pipe (not shown) to make the space surrounded by the display substrate 2, the frame glass 11, and the back substrate 3 a vacuum atmosphere of 10⁻⁶ torr or less by sealing the exhaust pipe.

This embodiment has been described with the thickness of the display substrate 2, the thickness of the back substrate 3, and the height of the frame glass 11 as 3 mm. However, the thicknesses must not necessarily be the same and are not limited to the foregoing value.

### First Embodiment

The frame glass 11 of the flat image display device according to the first embodiment will now be described. In FIG. 1, the frame glass 11 includes two long frame glasses 11ₐ and two frame glasses 11_{b} of a height H₁ and a width W₁.

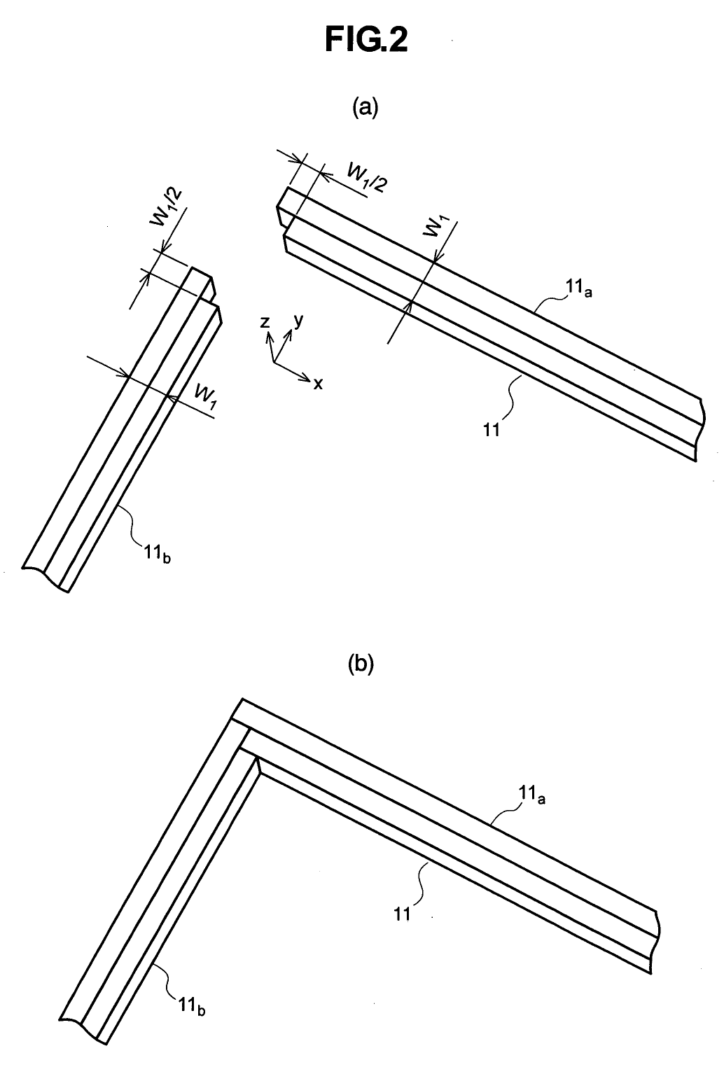

FIG. 2A is an enlarged exploded view of part of the frame glass 11 of FIG. 1; and FIG. 2B is an assembled view of the same. As shown in FIG. 2A, both ends of the frame glasses 11ₐ and 11_{b} (only one side is shown) each have two steps. The frame glasses 11ₐ and 11_{b} have a structure in which two glasses are bonded together in parallel with the substrates 2 and 3, as shown in the drawing, so that they can easily be formed by cutting the glasses to the height H₁. The accuracy of cutting the glasses can be relatively easily provided. Thus, little clearance is produced over the joint surface between the frame glass 11 and the display substrate 2 and between the frame glass 11 and the back substrate 3. The steps at the ends of the frame glasses 11ₐ and 11_{b} can easily be produced by shifting the ends by W₂/2 when the two glasses are bonded.

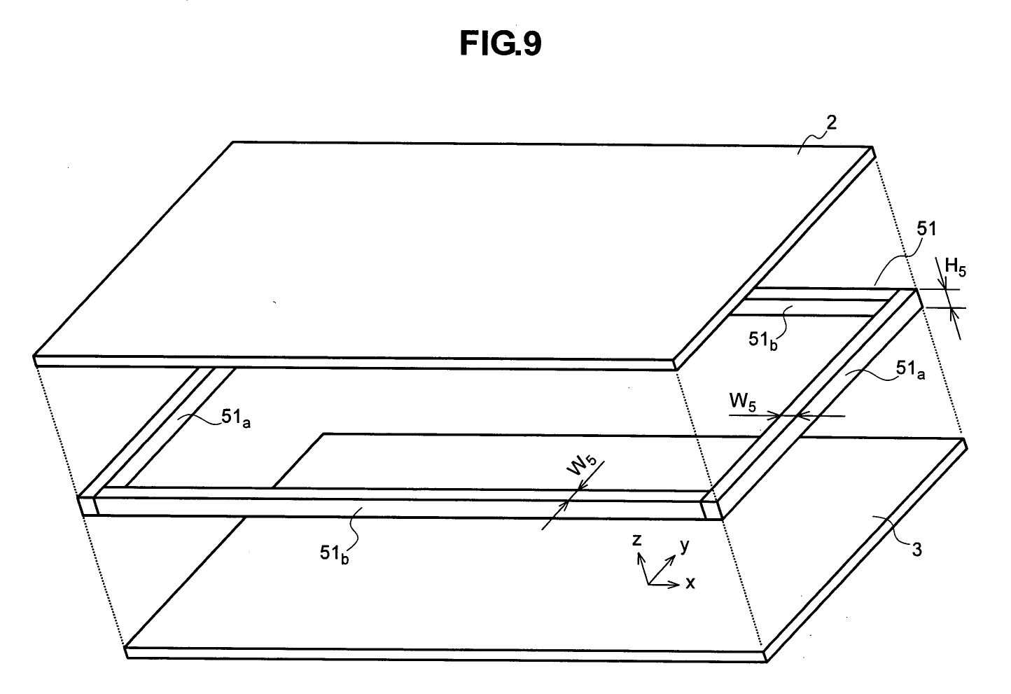

In assembly, as shown in FIG. 2B, the step at the end of the frame glass 11ₐ and the step at the end of the frame glass 11_{b} are brought into engagement with each other and bonded together with an adhesive (not shown). In that case, they are bonded across two surfaces, the x-z surface and the y-z surface. This ensures a high bonding strength in the x-direction and the y-direction. The bonding strength is low for the stress in the z-direction in which the joint surface is sheared. However, the stress applied to the joint surface seldom contains only a force that is completely parallel to the z-axis but also has the x-directional or z-directional component. Thus, this embodiment has a high bonding strength. When H₁=H₅ and W₁=W₅ hold relative to the height H₅ and the width W₅ of the frame glass of FIG. 9, the joint area is about 1.5 times as large as that of FIG. 9. Thus, the bonding strength is also increased.

When the frame glasses 11ₐ and 11_{b} are produced by bonding two glasses with a thin plastic or polycarbonate sheet sandwiched therebetween, the strength of the frame glasses can be increased.

Since the first embodiment has a structure in which the cut frame glasses are bonded together, as described above, little clearance is produced between the frame glass and the display substrate and between the frame glass and the back substrate. Therefore, there is no need to apply wasteful sealant. Since the ends of the frame glasses are shaped like a step, and they are fitted and bonded to each other, the joint area can be larger than that of conventional one and as such, the bonding strength of the joint portion between the frame glasses can be increased. Accordingly, the joint portion between the frame glasses can be prevented from coming off in assembling a flat image display device. Furthermore, the strength against the pressure difference between the inside and the outside of the device can be controlled by increasing or decreasing the number of glasses irrespective of the height H of the frame glass.

### Second Embodiment

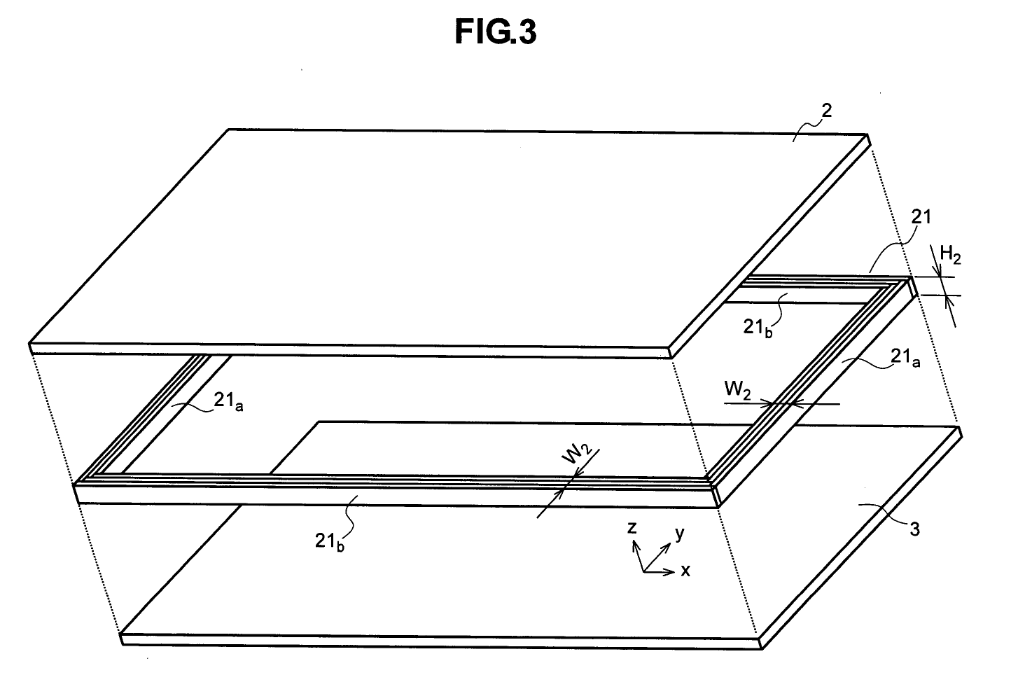

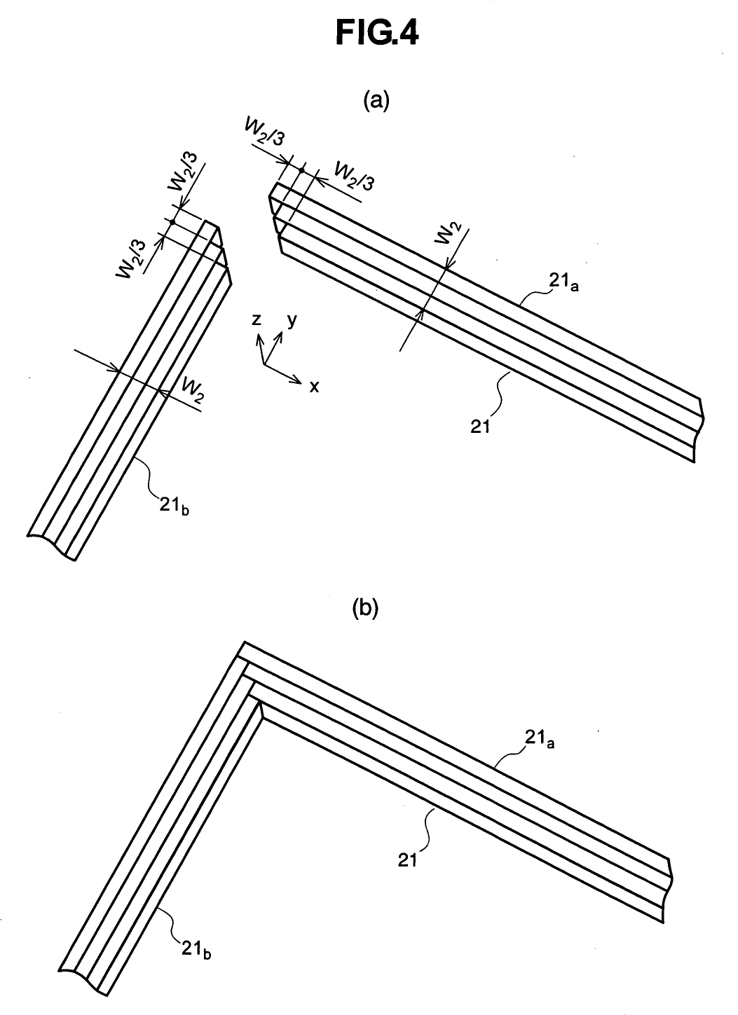

A second embodiment of the invention will then be described. FIG. 3 is a schematic diagram of a flat image display device according to the second embodiment; FIG. 4A is an enlarged exploded view of part of a frame glass 21 of FIG. 3; and FIG. 4B is an assembled view of the same. In FIGS. 3, 4A, and 4B, the frame glass 21 includes two long frame glasses 21ₐ and two frame glasses 21_{b} of a height H₂ and a width W₂.

As shown in FIG. 4A, both ends of the frame glasses 21ₐ and 21_{b} (only one side is shown) each have three steps. The frame glasses 21ₐ and 21_{b} have a structure in which three glasses are bonded together, as shown in the drawing, so that they can easily be formed by cutting the glasses to the height H₂. The accuracy of cutting the glasses can be relatively easily provided, as in the first embodiment. Thus, little clearance is produced over the joint surfaces between the frame glass 21 and the display substrate 2 and between the frame glass 21 and the back substrate 3. The steps at the ends of the frame glasses 21ₐ and 21_{b} can easily be produced by shifting the ends by W₁/3 when the three glasses are bonded.

In assembly, as shown in FIG. 4B, the steps at the end of the frame glass 21ₐ and the steps at the end of the frame glass 21_{b} are brought into engagement with each other and bonded together with an adhesive (not shown) In this case, they are bonded across two surfaces, the x-z surface and the y-z surface, as in the first embodiment. This ensures a high bonding strength in the x-direction and the y-direction. The bonding strength is low for the stress in the z-direction in which the joint surface is sheared. However, the stress applied to the joint surface seldom contains only a force that is completely parallel to the z-axis but also has the x-directional or z-directional component. Thus, this embodiment has a high bonding strength. When H₂=H₅ and W₂=W₅ hold, the joint area is about 1.67 times as large as that of FIG. 9. Thus, the bonding strength is also increased. Furthermore, the height H of the frame glass can be decreased because of no limitation to the height H.

Other embodiments in which a frame glass is made of four or more glasses, the end faces of which have four steps, can provide the similar advantages.

### Third Embodiment

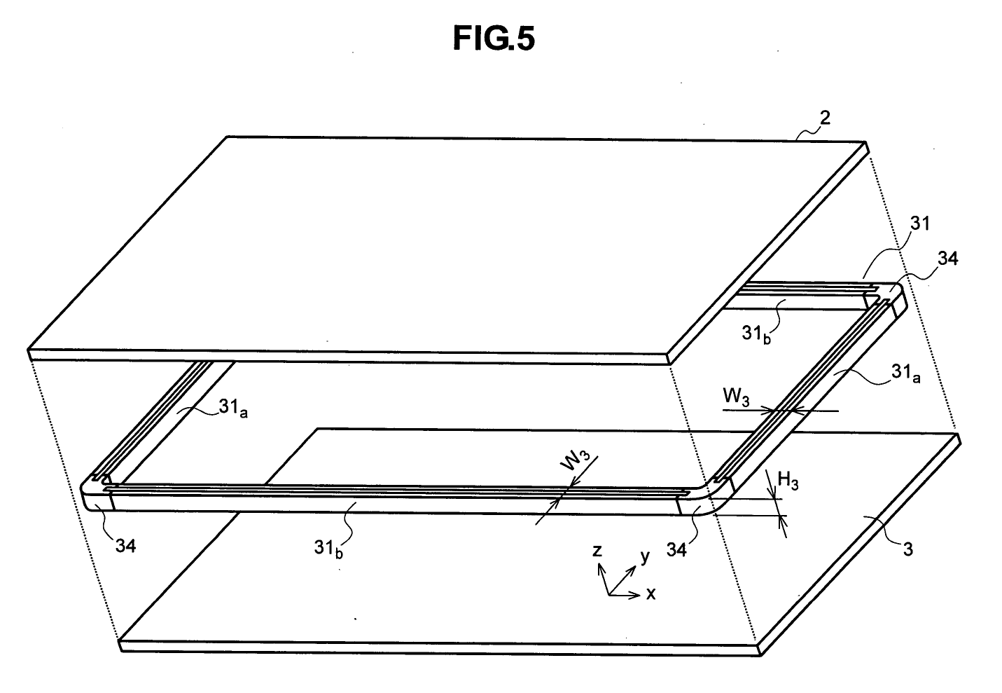

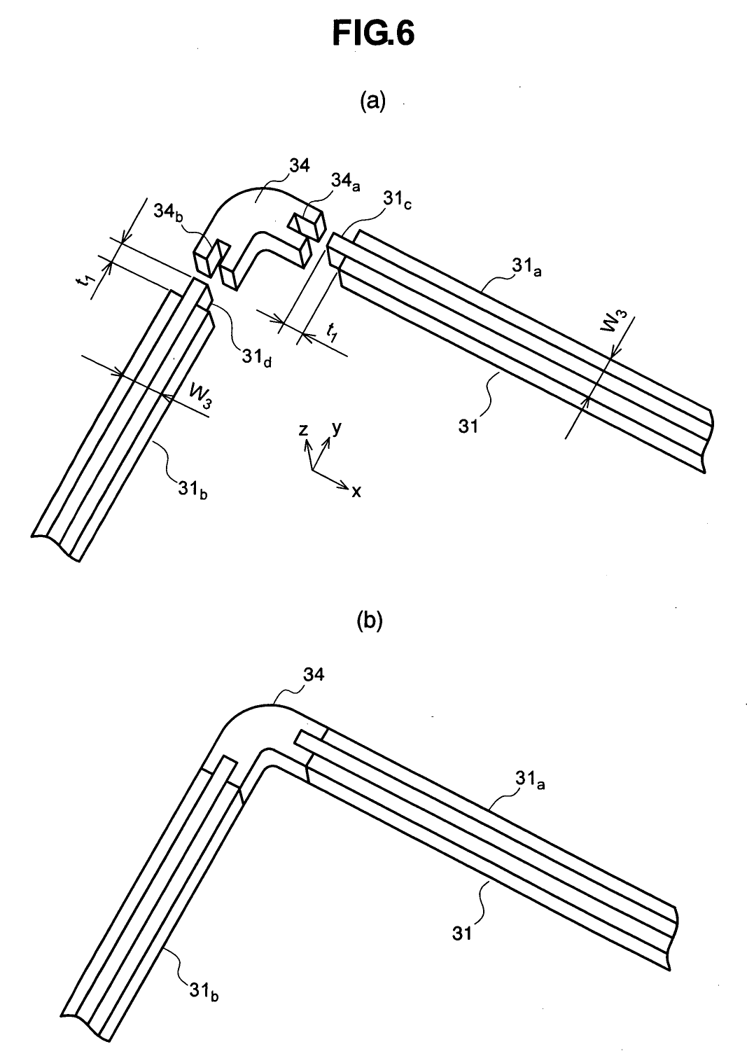

A third embodiment will then be described. FIG. 5 is a schematic diagram of a flat image display device according to the third embodiment; FIG. 6A is an enlarged exploded view of part of a frame glass 31 of FIG. 5; and FIG. 6B is an assembled view of the same. In FIGS. 5, 6A, and 6B, the frame glass 31 includes two long frame glasses 31ₐ and two frame glasses 31_{b} of a height H₃ and a width W₃ and four corner glasses 34 to connect them.

As shown in FIG. 6A, both ends of the frame glasses 31ₐ and 31_{b} (only one side is shown) have projections 31_{c} and 31_{d}, respectively. The frame glasses 31ₐ and 31_{b} have a structure in which three glasses are bonded together, as shown in the drawing, so that they can easily be formed by cutting the glasses to the height H₃. The accuracy of cutting the glasses can be relatively easily provided, as in the first embodiment. Thus, little clearance is produced over the joint surfaces between the frame glass 31 and the display substrate 2 and between the frame glass 31 and the back substrate 3. The projections 31_{c} and 31_{d} at the ends of the frame glasses 31ₐ and 31_{b} can easily be produced by shifting the ends by t₁ when the three glasses are bonded. The corner glasses 34 are produced by molding crystallized glass and so on. The corner glasses 34 each have recessed portions 34ₐ and 34_{b} corresponding to the projections 31_{c} and 31_{d}. In assembly, the projections 31_{c} and 31_{d} of the frame glasses 31ₐ and 31_{b} are fitted in the recessed portions 34ₐ and 34_{b} of the corner glass 34, as shown in FIG. 6B. Then they are bonded together to form the frame glass 31.

According to the third embodiment, they are bonded across two surfaces, the x-z surface and the y-z surface, as in the first and second embodiments. This ensures a high bonding strength in the x-direction and the y-direction. The bonding strength is low for the stress in the z-direction in which the joint surface is sheared. However, the stress applied to the joint surface seldom contains only a force that is completely parallel to the z-axis but also has the x-directional or z-directional component. Thus, this embodiment has a high bonding strength. Furthermore, since two joint portions are provided for one corner, the stress applied to the corner can be distributed to the two joint portions. This reduces the stress to one joint portion by half. It is preferable to dispose the joint portion about 2 mm apart from the corner, so that the joint portion can be separated from the corner to which the stress is concentrated.

### Fourth Embodiment

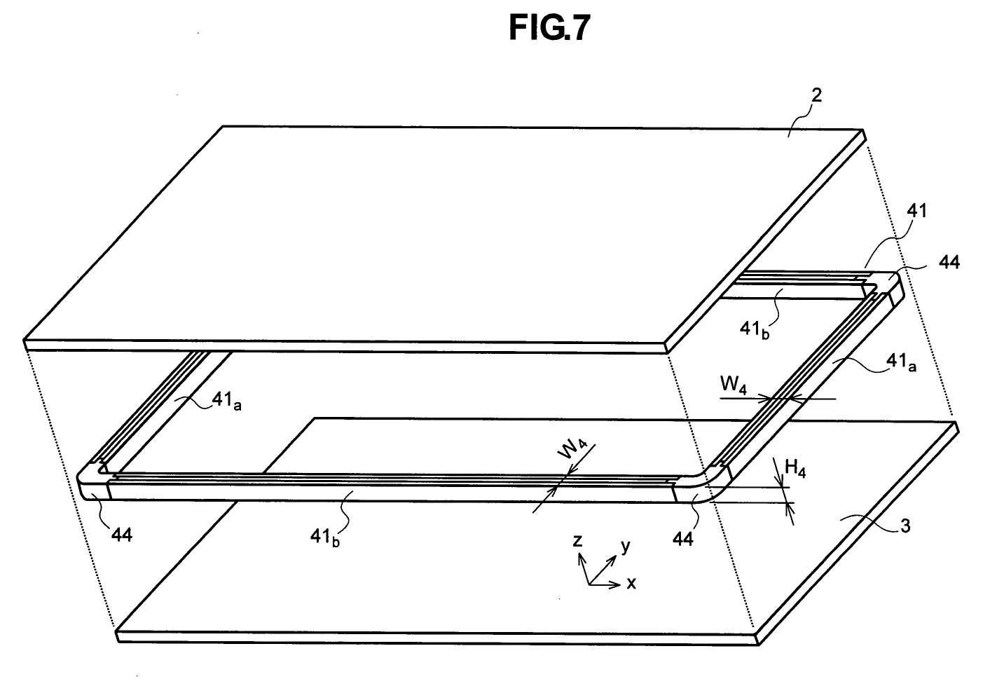

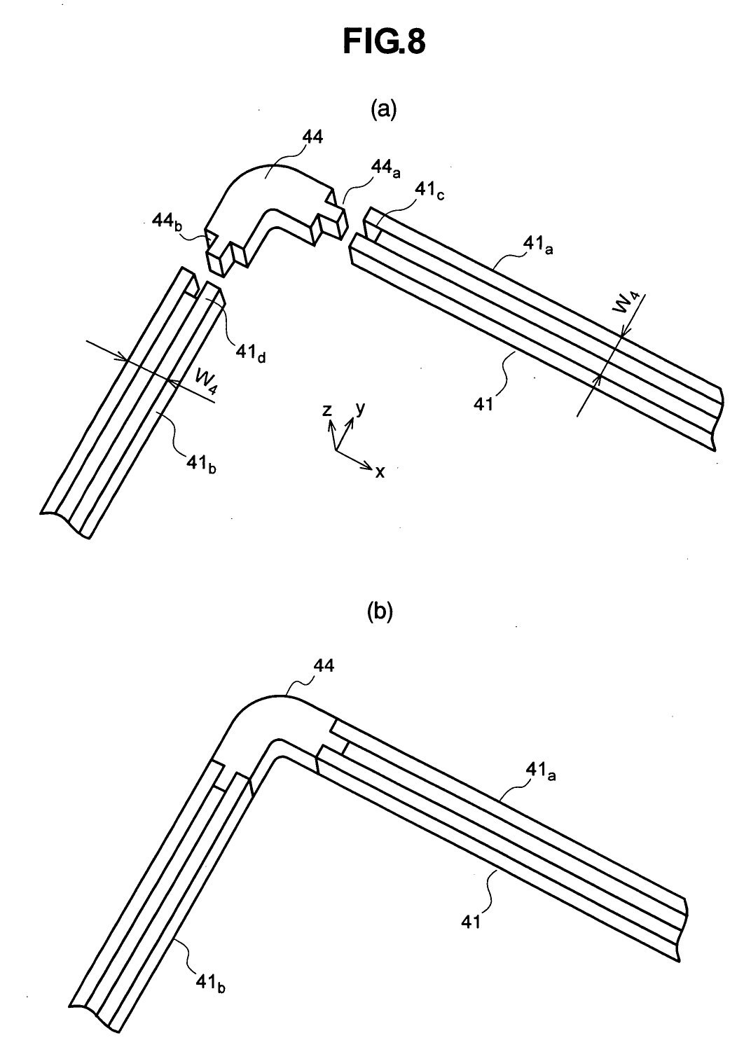

A fourth embodiment will then be described. FIG. 7 is a schematic diagram of a flat image display device according to the fourth embodiment; FIG. 8A is an enlarged exploded view of part of a frame glass 41 of FIG. 7; and FIG. 8B is an assembled view of the same. In FIGS. 7, 8A, and 8B, the frame glass 41 includes two long frame glasses 41ₐ and two frame glasses 41_{b} of a height H₄ and a width W₄ and four corner glasses 44 to connect them.

As shown in FIG. 8A, the corner glasses 44 each have projections 44ₐ and 44_{b}. The frame glasses 41ₐ and 41_{b} have recessed portions 41_{c} and 41_{d} corresponding to the projections 44ₐ and 44_{b}, respectively. The projections 44ₐ and 44_{b} are fitted in the recessed portions 41_{c} and 41_{d}, respectively, and are bonded together to form the frame glass 41. The fourth embodiment has a structure in which the recessed portions and the projections are opposite to those of the third embodiment, thus having the same advantages, so that the description will be omitted.

### Fifth Embodiment

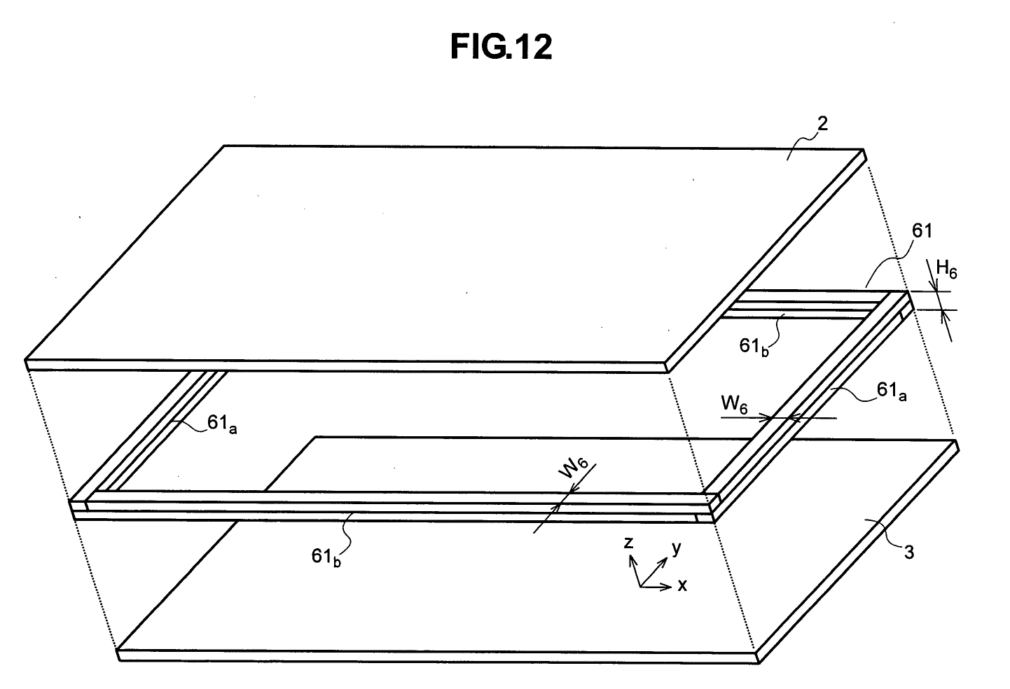

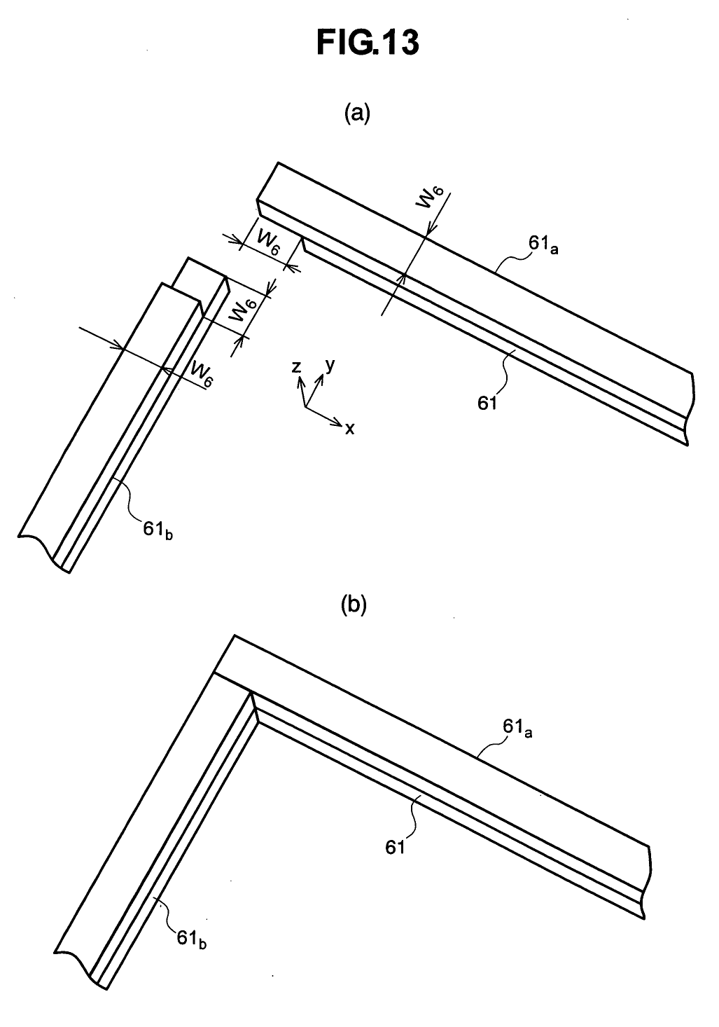

A fifth embodiment will then be described.. FIG. 12 is a schematic diagram of a flat image display device according to the fifth embodiment; FIG. 13A is an enlarged exploded view of part of a frame glass 61 of FIG. 12; and FIG. 13B is an assembled view of the same. In FIGS. 12, 13A, and 13B, the frame glass 61 includes two long frame glasses 61ₐ and two frame glasses 61_{b} of a height H₆ and a width W₆.

As shown in FIG. 13A, both ends of the frame glasses 61ₐ and 61_{b} (only one side is shown) each have two steps. The frame glasses 61ₐ and 61_{b} have a structure in which two glasses are bonded together in the direction substantially perpendicular to the substrates 2 and 3, as shown in the drawing, so that they can easily be formed by cutting the glasses to the width W₆. The flatness of the surface of the frame glass 61 may be of float glass. Thus, little clearance is produced on the joint surfaces between the frame glass 61 and the display substrate 2 and between the frame glass 61 and the back substrate 3. The steps at the ends of the frame glasses 61ₐ and 61_{b} can easily be produced by shifting the ends by W₆ when the two glasses are bonded. Furthermore, the upper glass and the lower glass can be equal in length by alternating the lower projecting frame glass and the upper recessed frame glass, as shown in FIG. 12.

In assembly, as shown in FIG. 13B, the step at the end of the frame glass 61ₐ and the step at the end of the frame glass 61_{b} are brought into engagement with each other and bonded together with an adhesive (not shown) In this case, they are bonded across three surfaces, the x-y surface, the x-z surface, and the y-z surface.

When the frame glasses 61ₐ and 61_{b} are produced by bonding two glasses with a thin plastic or polycarbonate sheet sandwiched therebetween, the strength of the frame glasses can be increased.

Since the fifth embodiment has a structure in which the cut frame glasses are bonded together, as described above, little clearance is produced between the frame glass and the display substrate and between the frame glass and the back substrate. Therefore, there is no need to apply wasteful sealant. Since the ends of the frame glasses are shaped like a step, and they are fitted and bonded to each other, the joint area can be larger than that of conventional one and as such, the bonding strength of the joint portion between the frame glasses can be increased. Accordingly, the joint portion between the frame glasses can be prevented from coming off in assembling a flat image display device. Furthermore, the accuracy of cutting the frame glass at width W is not required and the strength against the pressure difference between the inside and the outside of the device can be controlled by the width W.

### Sixth Embodiment

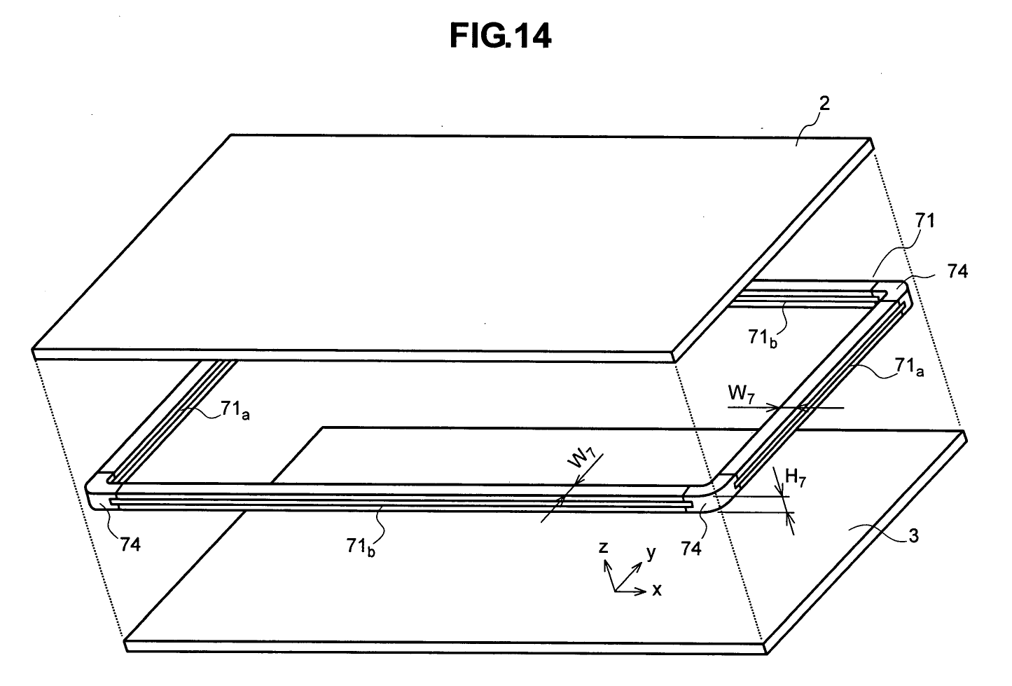

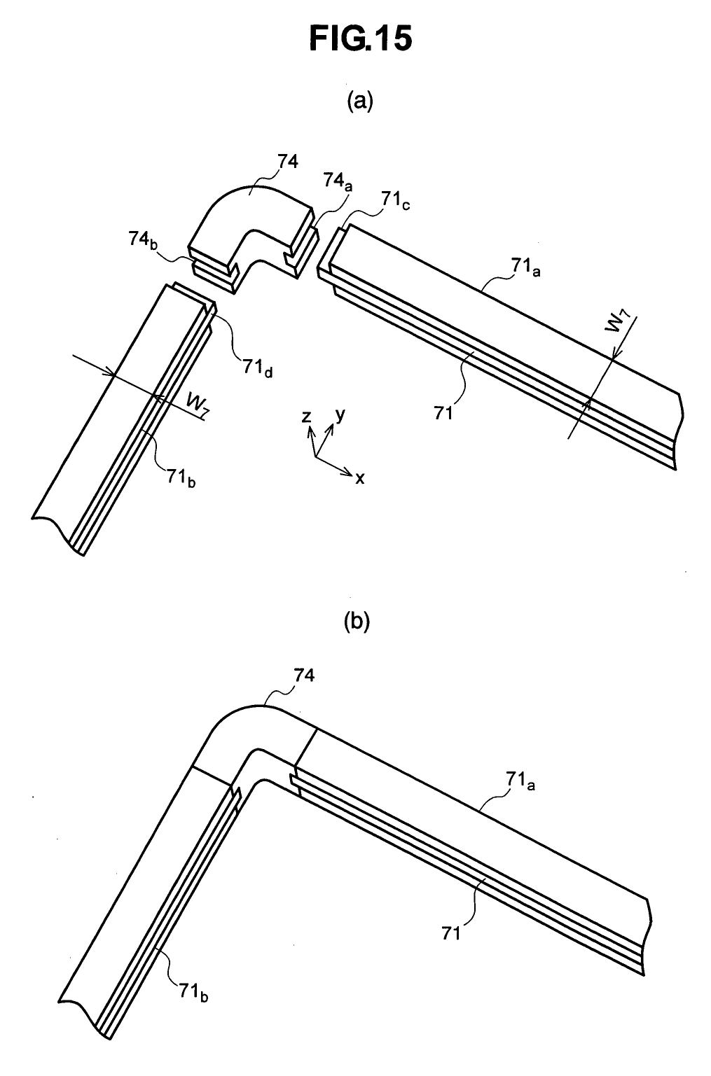

A sixth embodiment will then be described. FIG. 14 is a schematic diagram of a flat image display device according to the sixth embodiment; FIG. 15A is an enlarged exploded view of part of a frame glass 71 of FIG. 14; and FIG. 15B is an assembled view of the same. In FIGS. 14, 15A, and 15B, the frame glass 71 includes two long frame glasses 71ₐ and two frame glasses 71_{b} of a height H₇ and a width W₇ and four corner glasses 74 to connect them.

As shown in FIG. 15A, both ends of the frame glasses 71ₐ and 71_{b} (only one side is shown) have projections 71_{c} and 71_{d}, respectively. The frame glasses 71ₐ and 71_{b} have a structure in which three glasses are bonded together, as shown in the drawing, so that they can easily be formed by cutting the glasses to the width W₇. High flatness is required for the surface of the flame glass. The flatness of the surface of the frame glass 71 may be of float glass, as in the fifth embodiment. Thus, little clearance is produced on the joint surfaces between the frame glass 71 and the display substrate 2 and between the frame glass 71 and the back substrate 3. The projections 71_{c} and 71_{d} at the ends of the frame glasses 71ₐ and 71_{b} can easily be produced by shifting the ends when the three glasses are bonded. The corner glasses 74 are produced by molding crystallized glass and so on. The corner glasses 74 each have recessed portions 74ₐ and 74_{b} corresponding to the projections 71_{c} and 71_{d}. In assembly, the projections 71_{c} and 71_{d} of the frame glasses 71ₐ and 71_{b} are fitted in the recessed portions 74ₐ and 74_{b} of the corner glass 74, as shown in FIG. 15B. They are bonded together to form the frame glass 71.

According to the sixth embodiment, they are bonded across two surfaces of the x-y surface and the y-z surface, or two surfaces of the x-y surface and the z-x surface. This ensures a high bonding strength in the x-direction and the z-direction. Furthermore, since two joint portions are provided for one corner, the stress applied to the corner can be distributed to the two joint portions. This increases the bonding strength, and allows the joint portions to be separated from a point to which the stress is concentrated.

### Seventh Embodiment

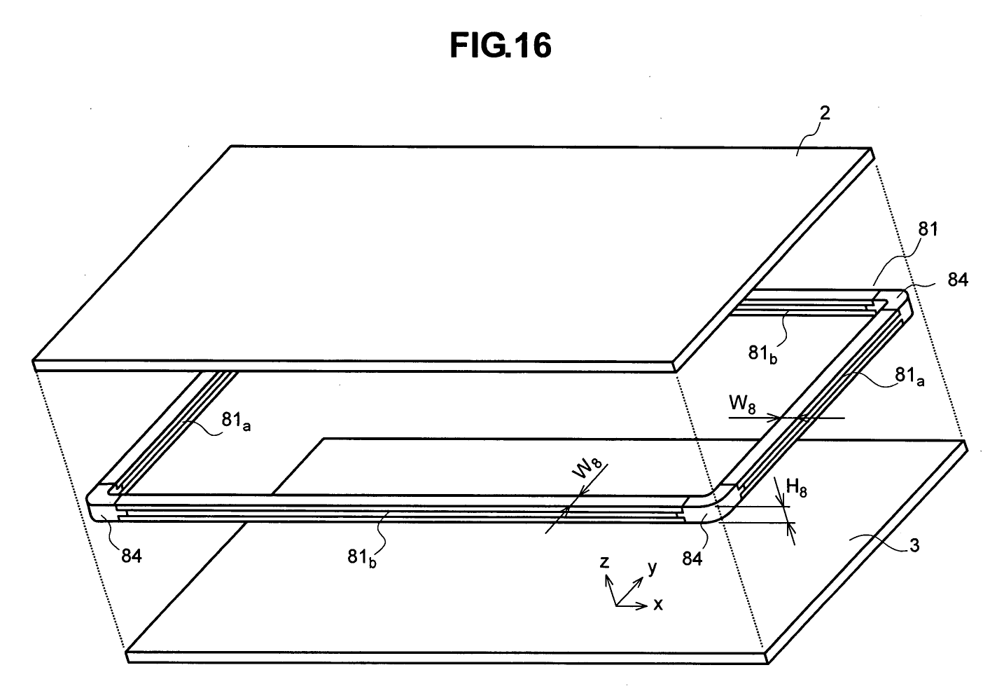

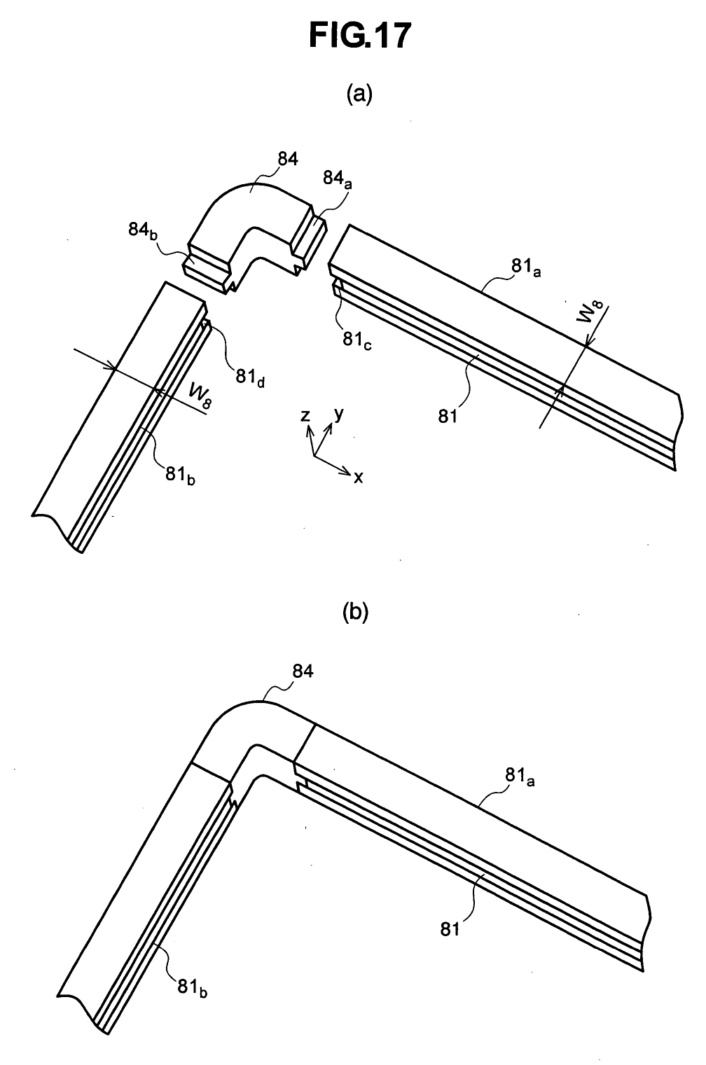

A seventh embodiment will then be described. FIG. 16 is a schematic diagram of a flat image display device according to the seventh embodiment; FIG. 17A is an enlarged exploded view of part of a frame glass 81 of FIG. 16; and FIG. 17B is an assembled view of the same. In FIGS. 16, 17A, and 17B, the frame glass 81 includes two long frame glasses 81ₐ and two frame glasses 81_{b} of a height H₈ and a width W₈ and four corner glasses 84 to connect them.

As shown in FIG. 17A, the corner glasses 84 each have projections 84ₐ and 84_{b}. The frame glasses 81ₐ and 81_{b} have recessed portions 81_{c} and 81_{d} corresponding to the projections 84ₐ and 84_{b}, respectively. The projections 84ₐ and 84_{b} are fitted in the recessed portions 81_{c} and 81_{d}, respectively, and are bonded together to form the frame glass 81. The seventh embodiment has a structure in which the recessed portions and the projections are reversed to those of the sixth embodiment, thus having the same advantages. Furthermore, since two joint portions are provided for one corner, the stress applied to the corner can be distributed to the two joint portions. This increases the bonding strength, and allows the joint portions to be separated from a point to which the stress is concentrated.

While an MIM-FED flat image display device has been described in the above embodiments, the invention can be applied to other FEDs. It is to be understood that the invention can be applied to a self-luminous flat image display device that uses a support frame of 0.5 mm or more in height whose interior is vacuum-sealed.

What is claimed is:

1. A flat image display device comprising:
a display substrate;
a back substrate disposed opposite the display substrate with a specified clearance therebetween; and
a frame glass disposed around the back substrate and the display substrate, for supporting the substrates with the specified clearance therebetween;
wherein the frame glass includes frame glasses whose ends each have at least two steps, the stepped ends being in engagement with each other and bonded together.

2. The flat image display device according to claim 1, wherein the frame glass is produced by bonding the same number of plate glasses as that of the steps at the ends.

3. The flat image display device according to claim 2, wherein the plate glasses are bonded with the ends of the adjacent plate glasses shifted by W/n, where W is the width of the frame glass and n is the number of bonded plate glasses.

4. A flat image display device comprising:
a display substrate;
a back substrate disposed opposite the display substrate with a specified clearance therebetween; and
a frame glass disposed around the back substrate and the display substrate, for supporting the substrates with the specified clearance therebetween;
wherein the frame glass includes a frame glass whose end has a projection and a corner glass whose end has a recessed portion, the projecting end of the frame glass is fitted in the recessed end of the corner glass and bonded together.

5. The flat image display device according to claim 4, wherein the frame glass is produced by bonding three plate glasses.

6. The flat image display device according to claim 4, wherein the corner glass is produced by molding.

7. A flat image display device comprising:
a display substrate;
a back substrate disposed opposite the display substrate with a specified clearance therebetween; and
a frame glass disposed around the back substrate and the display substrate, for supporting the substrates with the specified clearance therebetween;
wherein the frame glass includes a frame glass whose end has a recessed portion and a corner glass whose end has a projection, the projecting end of the corner glass is fitted in the recessed end of the frame glass and bonded together.

8. The flat image display device according to claim 7, wherein the frame glass is produced by bonding three plate glasses.

9. The flat image display device according to claim 7, wherein the corner glass is produced by molding.
